(19) United States
(12) Patent Application Publication
(10) Pub. No.: US 2007/0006418 A1
(43) Pub. Date: Jan. 11, 2007

(54) Break free magnetic doorstop

(76) Inventor: Christina May Jones, Layton, UT (US)

Correspondence Address: CHRISTINA M. PERONEK, 2875 North 400 West Lot # 151, Layton, UT, 84041, US

(21) Appl. No.: 11/102,922

(22) Filed: Jul. 11, 2005

(51) Int. Cl. E05F 5/02

(52) U.S. Cl. 16/82

(57) ABSTRACT

A standard doorstop is a solid unit that is screwed into the wood baseboard/wall If hit with a vacuum, foot, and or any other objects, it tears away from the baseboard causing damage to the wooden base board/wall. The Break Free Doorstop consists of two pieces a metal mounting base with screw (to mount into baseboard) and a magnet that has been inserted into the doorstop itself to be attached to the mounting base. With this different feature that no solid doorstop can offer, the Break Free Doorstop if hit by a vacuum, foot, or other objects, will break free from the mounting base, causing no damage or repairs to the wooden baseboard/wall. When removed from mounting base it is easily snapped back onto mounting base.

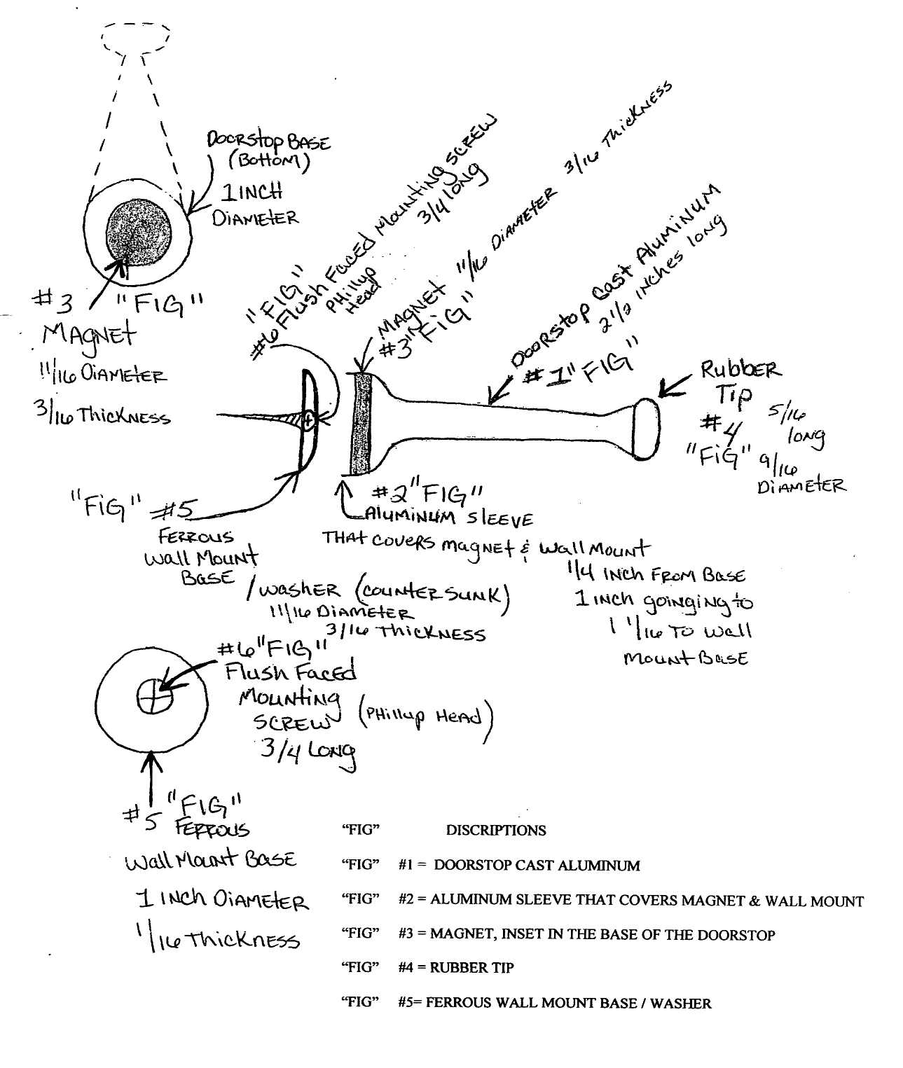

The funtion of the break free magnetic doorstop is that the doorstop unit is ment to break free from the wall mount when bumped/kicked/hit, (bumped by vacum—bumped by foot etc.).

The doorstop is removeable by putting a magnet at the base of the door stop, and having a magnetic wall mounting, making it two seperate parts.

The doorstop will consist of the following parts that are all connected to make one full unit.

#1. The doorstop

#2. The sleeve, that conceals the magnet at the base of the doorstop, and when attatched to the wall mount it will conceal that too, making it appear to look like a solid unit.

#3. The magnet, ment to hold the doorstop to the wall mounting, making it removeable without damage to the wall or the doorstop unit.

#4. The rubber tip, is connected to the tip of the doorstop to help cushion the door when touched. The ferrous wall mount base will consist of the following,

#5. The wall mount base/counter sunk washer, that will be permanetly attached to the wall or base board or where ever needed, that will be of a ferrous metal allowing it to adhere to the magnetic doorstop unit.

#6. The flush faced mounting screw, that will attach the wall mounting to the wall.
# 1. Doorstop cast aluminum. Size of doorstop 2½ inches long*
   * Sizes are approximate
# 2. Sleeve cast aluminum. Size of sleeve ¼ inches long & 1 inch in diameter* sleeve is a part of the doorstop at the base.
# 3. Magnet. Magnet is 11/16 in diameter & 3/16 in thickness* magnet is inset in sleeve of doorstop.
# 4. Rubber tip. Rubber tip is 5/16 long & 9/16 in diameter.* Rubber tip is part of the doorstop.
# 5. Ferrous wall mount base. Ferrous wall mount base/washer is counter sunk. Ferrous wall mount base is 1 inch in diameter,* and 1/16 in thickness.*
# 6. Flush faced mounting screw. Flush faced mounting screw is ¾ long,* with a phillup head.

1. The two piece magnetic Break Free Doorstop does not damage wooden baseboards/walls because of it's unique design of a two part system.
The two part system contains a metal mounting base with screw (to mount into baseboard/wall) and a magnet that has been inserted into the doorstop itself to be attached to the mounting base.
With this different system that no solid doorstop can offer, my claim is that when the Break Free Doorstop is hit, bumped, knocked with any object it breaks freely away from it's mounting base with out damage to the baseboard/wall and than can be replaced back on it's mounting base with ease.
